(19) United States
(12) Patent Application Publication
(10) Pub. No.: US 2006/0248952 A1
(43) Pub. Date: Nov. 9, 2006

(54) A METHOD AND APPARATUS FOR FLUID DENSITY SENSING

(75) Inventor: Ian F. Jarvie, Woodridge, IL (US)

Correspondence Address: WOOD, HERRON & EVANS, LLP, 2700 CAREW TOWER, 441 VINE STREET, CINCINNATI, OH, 45202, US

(73) Assignee: Delaware Capital Formation, Inc., Wilmington, DE (US)

(21) Appl. No.: 11/381,428

(22) Filed: May 3, 2006

Related U.S. Application Data
(60) Provisional application No. 60/679,261, filed on May 9, 2005.

(51) Int. Cl. G01N 9/00

(52) U.S. Cl. 73/444

(57) ABSTRACT

Methods and apparatus for measuring density of a fluid. The apparatus includes a shaft adapted to be positioned within a fluid and a biased float disposed on the shaft and capable of movement along the shaft. The apparatus further includes a displacement sensor for detecting a position of the float along the shaft. A method of sensing the density includes positioning the biased float in the fluid and sensing the position of the float to obtain data representative of the density of the fluid.

This application claims priority to provisional patent application Ser. No. 60/679,261 filed on May 9, 2005, the disclosure of which is expressly incorporated by reference herein in its entirety.

### FIELD OF THE INVENTION

The present invention generally relates to methods and apparatus for fluid density sensing. More particularly, the present invention relates to methods and apparatus for sensing or measuring density of a fluid within a container such as a storage tank using a spring-biased float and displacement sensor configured to sense the density of the fluid based upon the position or displacement of the float.

### BACKGROUND OF THE INVENTION

There are many conventional applications requiring the measurement of fluid parameters, such as fluid level, within containers. One exemplary application is storage tanks (both above ground and underground) used to store fuel. For example, most gasoline stations have one or more underground storage tanks below ground to store the gasoline available for sale to customers. These tanks may range in size (e.g., 20,000 gallons) and in use, generally contain a stratified fuel sitting atop an inch or two of water.

Due to the flammable nature of fuel and its potential harmful impact on the environment, governmental agencies require and the owner's desire the monitoring of certain parameters (e.g., fluid level) of the fuel contained within the tank to detect any leakage of the fuel from the tank to enable the appropriate actions to be taken to prevent any further leakage. For example, EPA standards state that a change in fuel level greater than 0.2 gallons/hour constitutes a leak. There are a variety of probes, sensors, and systems designed to measure the fuel level within these tanks, which is then used for fluid volume and tank leak detection calculations.

A variable used in the calculation of fluid volume and leak detection is fluid density. In many monitoring systems, fluid density is entered into the system manually, such as by a system operator. Such manual processes, however, may give rise to errors in the calculations. For example, discrepancies between the fluid's actual density and the system's input density may stem from many sources including: keystroke errors, entry of an approximate density for the particular fluid, incorrectly reading a separate density measuring device, measuring the density of a fluid sample that is not representative of the fluid in the tank (such as a sample taken from the delivery tanker), and others. These errors in the density measurement may then result in incorrect volume calculations and inaccurate leak detection results. Thus, it is desirable to provide highly accurate fluid density values in order to provide highly accurate fluid volumes and leak detection calculations.

Various density-sensing devices have been used to monitor the density of a fluid. For instance, some monitoring systems utilize ultrasonic densitometers to take fluid density measurements. These devices typically correlate the impedance to the ultrasonic wave to the density of the liquid through which the wave travels. Ultrasonic densitometers, however, are generally costly and often unreliable. Other density-sensing devices include a vibrating tube that measures the density of a fluid by administering a tap causing the tube to vibrate at resonant frequency. These devices typically correlate the frequency of the vibration to the density of the fluid. In these type of devices, however, the vibration frequency of the tube is not solely based on density due to the fact that density is affected by other variables such as mass flow rate and temperature. Thus, vibrating tube devices do not always provide accurate density measurements. Additionally, these devices are also cost prohibitive.

It is accordingly an objective of the invention to provide improved fluid density-sensing methods and apparatus that provide highly accurate, real-time density measurements which may be used to provide improved fluid volume and leak detection capabilities.

### SUMMARY OF THE INVENTION

To these ends, one exemplary embodiment of an apparatus for sensing the density of a fluid includes a shaft adapted to be positioned in the fluid, a biased float disposed on the shaft and capable of movement along the shaft, and a displacement sensor for detecting the position of the float along the shaft, wherein the apparatus is configured to sense the density of the fluid based on the position of the float.

Another exemplary embodiment of an apparatus for sensing the density of a fluid includes a shaft adapted to be positioned in a fluid within a container. A float assembly is disposed on the shaft and includes a mounting plate secured to the shaft, a spring having first and second ends, the first end adapted to engage the mounting plate, and a float adapted to engage the second end of the spring and capable of movement along the shaft. The apparatus further includes a displacement sensor having a magnetostrictive waveguide disposed along the shaft, a magnet operatively coupled to the float for movement therewith and in operative relation to the magnetostrictive waveguide, and pulsing and detection apparatus for detecting a position of the magnet along the waveguide, wherein the apparatus is configured to sense the density of the fluid based on the position of the float. The apparatus may further include at least one product float to sense the level of the fluid in the container thereby providing a multi-functional device.

Another exemplary embodiment includes a density sensor kit for retrofitting a product level sensor. The product level sensor includes a shaft adapted to be positioned in a fluid within a container, at least one product float movably disposed on the shaft, and a displacement sensor including a magnetostrictive waveguide disposed along the shaft, and pulsing and detection apparatus for detecting a position of a magnet along the magnetostrictive waveguide. The retrofit kit includes a float assembly having a mounting plate adapted to be selectively secured to the shaft, a spring having a first end adapted to engage the mounting plate and a second end adapted to engage a float configured for movement along the shaft when coupled thereto, and a magnet adapted to be coupled to the float, wherein the float assembly is configured to sense the density of the fluid based on the position of the float.

Yet a further exemplary embodiment includes a method for sensing the density of a fluid and includes positioning a float within the fluid, wherein the float has a buoyancy with respect to the fluid, biasing the float against it buoyancy in the fluid, and sensing the position of the float to obtain data representative of the density of the fluid. In one particular embodiment, the position of the float is sensed magnetostrictively by causing relative movement of the magnetostrictive waveguide or the magnet operatively disposed proximate the waveguide upon movement of the float.

### BRIEF DESCRIPTION OF THE DRAWINGS

While the specification concludes with claims particularly pointing out and distinctly claiming the invention, embodiments of the invention will be better understood from the following description taken in conjunction with the accompanying drawings in which:

FIG. 1 is a schematic view of an exemplary fuel dispensing system in which various embodiments of the invention may be used;

FIG. 2 is a front elevational view in partial cross section of an embodiment of a density-sensing apparatus in accordance with the invention;

FIG. 3 is a front elevational view in partial cross section of another embodiment of a density-sensing apparatus in accordance with the invention; and

FIG. 4 is a front elevational view in partial cross section of yet another embodiment of a density-sensing apparatus in accordance with the invention.

The embodiments set forth in the drawings are illustrative in nature and not intended to be limiting of the invention, which is defined by the claims. Moreover, individual features illustrated in the drawings will be more fully apparent and understood with reference to the following detailed description.

### DETAILED DESCRIPTION

Reference will now be made in detail to various embodiments of the invention, examples of which are illustrated in the accompanying drawings, wherein like numerals indicate similar elements throughout the views.

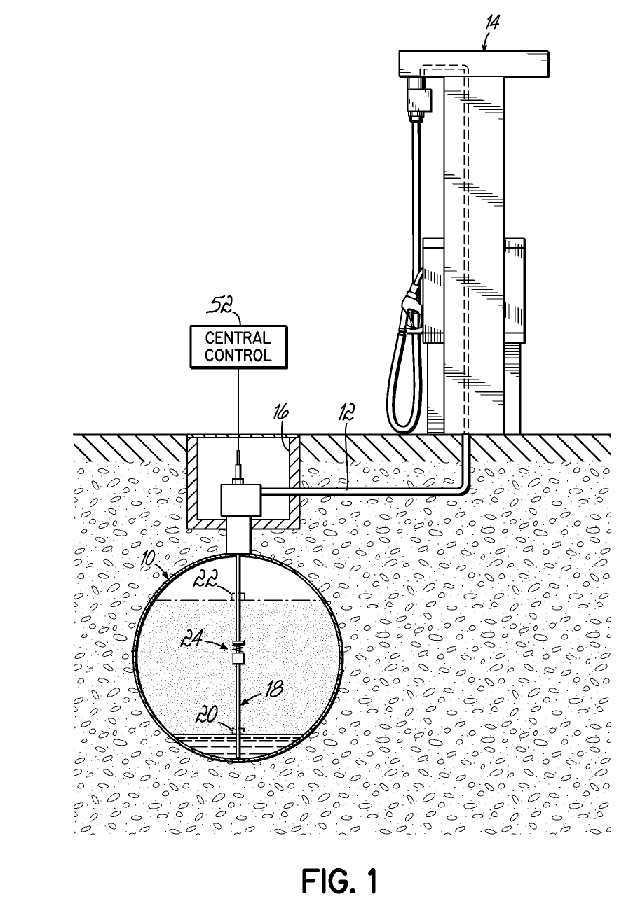

An exemplary fuel dispensing system is shown in FIG. 1 and generally includes an underground storage tank (“UST”) 10 for storing a fuel, a submersible pump (not shown), and a fluid conduit line 12 that transports the fuel under pressure to one or more dispensing units 14. Typically, the fluid conduit line 12 is coupled to the submersible pump via a pump manifold 16 that is typically located external to the tank 10, such as in a covered manway. As mentioned above, to meet EPA regulations, the integrity of the tank 10 must be regularly tested and the amount of any fuel leakage thererfrom monitored.

To this end, the dispensing system typically includes a product level probe 18 inserted through a port in manifold 16 and having one or more product floats for determining the level of the fluid within tank 10. In the embodiment shown in FIG. 1, the product level probe 18 includes a lower product float 20 for determining the level of water in tank 10 and an upper product float 22 for determining the level of fuel in tank 10. As discussed in more detail below, some product level probes used to determine leakage as a function of level change may use magnetostrictive technology to provide highly accurate measurements of the fluid levels in tank 10. An exemplary product level probe is commercially available as the Model 924 probe from OPW Fuel Management Systems, Inc. of Hodgkins, Ill. The fluid level measurements may be used by the dispensing system for fluid volume and tank leak detection calculations.

One particular use of the invention is in a dispensing system such as shown schematically in FIG. 1, although the invention has other advantageous uses as will be appreciated. In particular, with reference to FIG. 1, a density-sensing apparatus 24 is inserted through a port in manifold 16 and positioned within tank 10 to provide real-time density measurements of the fluid (e.g., fuel, water) in the tank 10. As explained above, providing density measurements to the dispensing system using density-sensing apparatus 24 avoids the drawbacks associated with manual type processes and further provides highly accurate density measurements that improve the fluid volume and leak detection calculations.

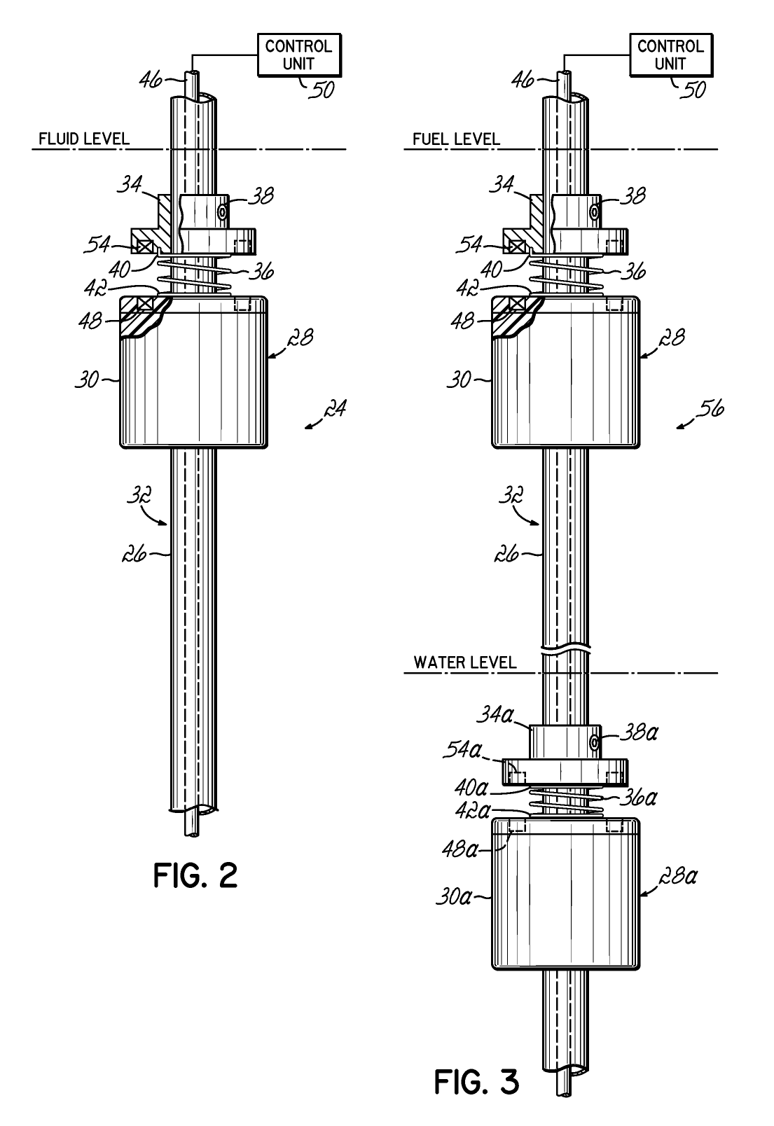

As shown in FIG. 2, and in an exemplary embodiment of the invention, the density-sensing apparatus 24 generally includes a shaft 26 that operates as a framework for the device, a float assembly 28 having a float 30 movable along shaft 26, and a displacement sensor 32 for measuring the location or displacement of the float 30 along shaft 26. Shaft 26 may be a hollow, generally cylindrical shaft (e.g., a sheath) having a variety of lengths and diameters. For example, it is desirable that the density-sensing apparatus 24, including the shaft 26 and the other components discussed in more detail below, be configured to have a diameter of about two inches or less such that the density-sensing apparatus 24 will fit through a standard port in the manifold 16 so as to access tank 10. Shaft 26 may be fabricated from any non-magnetic materials, including but not limited to metals (e.g., 316 stainless steel), plastics, fiberglass, etc. It is understood that the shaft 26 of density-sensing apparatus 24 may include a variety of configurations, shapes, and sizes (e.g., rectangular cross section) as known to one of ordinary skill in the art.

The float assembly 28 of the density-sensing apparatus 24 includes float 30, a mounting plate 34 proximate the float 30 and circumscribing shaft 26, and a biasing member, such as spring 36, intermediate the float 30 and mounting plate 34. In the exemplary embodiment, float 30 may be fabricated from a material that has a density lower than the fluid to be measured such that float 30 will float in the fluid, i.e., the float 30 will tend to rise in a direction opposite gravity when submersed in the fluid. For example, float 30 may be made from a material (e.g., a foam float) having a density less than 0.68 g/cc, which is the density of the lightest unleaded gasoline currently available. Thus when submersed in the heavier fluid medium, the float 30 will be displaced upwards a certain distance along shaft 26 due to the difference between the density of float 30 and the density of the fluid (i.e., a buoyancy force).

In one embodiment, as shown in FIG. 2, the mounting plate 34 may be positioned above the float 30 and securely coupled to shaft 26 using, for example, a set screw 38. In this way, mounting plate 34 may be selectively positioned along shaft 26 so as to be at a desired depth in tank 10 or to be within a particular fluid in tank 10. Moreover, spring 36 includes a first end 40 coupled to mounting plate 34 and a second end 42 that may be coupled to float 30. In this way, the float assembly 28 may be configured such that the buoyancy force moves float 30 toward the mounting plate 34 along shaft 26 and against the biasing force exerted by spring 36, which operates as a compression spring in this configuration. In another embodiment (not shown), the mounting plate 34 and spring 36 may be positioned below the float 30. In this way, the float assembly 28 is configured such that the buoyancy force moves float 30 away from the mounting plate 34 along shaft 26 and against the biasing force exerted by spring 36, which operates as an extension spring in this configuration. In either embodiment, when float 30 moves upward due to the buoyancy force, it moves against an opposing force applied by spring 36. It is understood that the coupling for spring 36 and/or mounting plate 34 may be accomplished using a variety of methods or devices as known to those of ordinary skill in the art. Those of ordinary skill in the art will further recognize that the biasing member is not limited to spring 36 as there are other ways to apply a biasing force against the buoyant movement of the float 30.

The movement of the float 30 along shaft 26 may be measured by displacement sensor 32. A variety of displacement sensors capable of measuring the displacement of float 30 along shaft 26 may be used, including but not limited to magnetostrictive, infrared, RF, and other known displacement sensors. In the exemplary embodiment shown, the location or displacement of float 30 may be measured using magnetostrictive technology. Magnetostriction relies on the material properties of transition metals. For example, when the material is not magnetized, the magnetic domains in these materials are arranged randomly. However, when a magnetic field is applied to the material, it causes all the magnetic domains to align. This alignment causes stress and pulling on the magnetic domains, which change the physical properties of the material (e.g., lengthening or mechanical twisting of the material). While magnetostrictive technology is generally known in the art, such sensors are not known to have been used heretofore in fluid density-sensing apparatus. Thus, while there has been a need to provide an improved density sensing capability, it is apparent the industry has not appreciated or recognized the potential use of magnetostrictive technologies and the advantages of the combination of that technology in density-sensing apparatus or in highly accurate tank leak detection, as will be discussed.

Accordingly, in the exemplary embodiment, the displacement sensor 32 may be configured as a mangetostrictive sensor including a magnetostrictive waveguide 46 disposed coaxially in the hollow shaft 26 and extending substantially the length thereof. As recognized by those of ordinary skill in the art, magnetostrictive waveguide 46 may be formed from a suitable ferromagnetic material, such as transition metals like iron, nickel, cobalt or combinations thereof. Magnetostrictive waveguide 46 may be configured as a wire (e.g., braided, wound, coaxial, etc.). For example, magnetostrictive waveguide 46 may comprise a heat-treated nickel ferrous Nispan C waveguide wire. The waveguide 46 may be heat treated to straighten and ensure uniformity of material properties through out its length such that waveguide 46 may maintain a constant velocity of a generated torsional wave (as explained later herein) so accurate time/distance readings may be made.

Displacement sensor 32 also includes a permanent magnet 48 coupled to float 30. Magnet 48 may comprise any magnets as known or yet-to-be developed by one of ordinary skill in the art. For instance, in the exemplary embodiment, magnet 48 may include two ring magnets (e.g., north pole inner ring and south pole outer ring) coupled to float 30. Alternatively, float 30 may be fabricated from a composite material that acts as a magnet and has a density lower than the fluid to be measured. In any event, the magnet 48 typically has an annular configuration having an opening through which magnetostrictive waveguide 46 may be positioned. In this way, as the float 30 moves due to buoyancy effects, the magnet 48 moves relative to magnetostrictive waveguide 46. The location or displacement of magnet 48 relative to magnetostrictive waveguide 46 can be sensed by displacement sensor 32 and may be used to determine the density of the fluid, as explained in more detail below.

Displacement sensor 32 further includes a sensor control unit, shown schematically at 50. Control unit 50 houses the necessary electrical components and systems for operation of displacement sensor 32, as will now be explained. In operation, control unit 50 includes an electrical pulse signal generator that generates and sends an interrogation current pulse (e.g., a one to three microsecond pulse) along the magnetostrictive waveguide 46. The interrogation pulse is transmitted down the magnetostrictive waveguide 46 creating an electromagnetic field along the length of the waveguide 46. The permanent magnet 48 also generates a magnetic field that interacts with the magnetic field from the interrogation pulse that causes a mechanical twisting (e.g., a change in the magnetic permability) of the magnetostrictive waveguide 46 (Wiedemann effect) at the location of the permanent magnet 48. The mechanical twisting of magnetostrictive waveguide 46 generates a torsional wave (e.g., a change in the magnetic flux density of the magnetostrictive material) that travels in the opposite directions from the magnet 48 along waveguide 46 (i.e., a return pulse in the form of an ultrasonic wave along the waveguide 46). The control unit 50 includes a transducer capable of detecting the return pulse. For example, the transducer may be any conventional transducer as known to or yet-to-be developed by one of ordinary skill in the art, including but not limited to a pickup coil, piezoelectric crystal, microphone or photoelectric cell. In the exemplary embodiment, the transducer is a pickup coil, e.g., a wire wrapped around a portion of the magnetostrictive waveguide 46. The control unit 50 may be electrically coupled to a central control 52 (FIG. 1), such as by a suitable cable, for collecting and analyzing the data signals from displacement sensor 32. Those of ordinary skill in the art will recognize that the transducer may be external to the control unit 50 or part of the control unit as described above. Those of ordinary skill in the art will further recognize that some, if not all, of the electrical components in the control unit 50 may alternately be located in the central control 52.

The location of float 30 along shaft 26 may be detected by applying an interrogation pulse to the magnetostrictive waveguide 46. At the same time, a high-speed counter located in control unit 50 is started. When the interrogation pulse reaches the permanent magnet 48, the return pulse is generated and travels back up magnetostrictive waveguide 46 and is detected by the transducer. The counter is then stopped. Since the speed of the return pulse in magnetostrictive waveguide 46 is known, i.e., speed of sound in the waveguide material (e.g., 111,000 in/sec), the elapsed time between the interrogation pulse and the returned pulse provides an indication of the position or location of float 30 along waveguide 46 in shaft 26.

The control unit 50 may be configured to calculate the density of the fluid at the density-sensing apparatus 24 based on the location (displacement) of the float 30, as measured by the displacement sensor 32. When the density-sensing apparatus 24 is submersed in the fluid in the tank 10, the float 30 moves upward due to buoyancy and against the force applied by spring 36 until the system comes into equilibrium. The location of the float 30 at equilibrium can be ascertained by displacement sensor 32 as explained above. This measured location can then be compared to a reference location of the float 30. For example, the reference location of float 30 may be defined to be the position of the float 30 when the spring 36 is at its uncompressed position. The invention is not so limited as those of ordinary skill in the art will recognize other reference locations that may be used in the invention. For instance, this reference location can be determined prior to insertion of the density-sensing apparatus 24 into tank 10. In this way, the difference between the measured location of float 30 via sensor 32 and the (pre-defined) reference location defines the amount that the spring 36 has been compressed (extended). Control unit 50 may be configured to calculate the spring force. Since the displacement (x) of the spring 36 (either under compression or extension) is determinable from the measurement and the spring constant (k) is generally known, the spring force (Fₛ) acting on float 30 may be calculated using Hooke's Law:
Fₛ=k x. (1)

A second force acting on float 30 will be a net force due to buoyancy. The second force is a net force because the buoyant force will account for and be stronger than the force due to gravity on the float. Control unit 50 may be configured to calculate the net force (F_{N}) using the following equation:
F_{N}=ρ_{fluid}*g*V_{float}−(M_{float}+M_{magnet})*g. (2)

From a static force balance, this net force (F_{N}) will be equal and opposite to the spring force (Fₛ) after the system reaches equilibrium. Since the gravitational constant (g), the mass of the float (M_{float}), mass of the magnet (M_{magnet}), volume of the float (V_{float}), and the spring force (Fₛ) will all be known, the control unit 50 may be configured to calculate the density of the fluid (ρ_{fluid}) by combining Equations 1 and 2 as shown below:

$${ρ}_{fluid} = \frac{kx + ( {M}_{float} + {M}_{magnet} ) * g}{g * {V}_{float}} \qquad ( 3 )$$

Thus, the determination of the location of the float 30 relative to its reference location, allows the density of the fluid to be calculated via control unit 50 using Equation (3) above.

As described above, the location of the float 30 may be calculated by measuring the time between when an interrogation pulse is generated and sent down the magnetostrictive waveguide 46 and when the transducer detects the return pulse generated by the permanent magnet 48 on float 30. While such a method operates effectively to locate the position of the float 30, the invention further contemplates other methods. For example, another approach is to place a second permanent magnet 54, similar to magnet 48, in the mounting plate 34. In this way, the interrogation pulse sent down the magnetostrictive waveguide 46 generates a return pulse for each of the magnets 48 and 54 along shaft 26, which is picked up by the transducer in control unit 50. The elapsed time between the two return pulses, which may be measured by the high-speed counter, then provides the distance between the mounting plate 34 and the float 30. Since the mounting plate 34 is located at a fixed position along shaft 26, it may be used as a reference point for determining the location of the float 30 and of the displacement of spring 36. In essence, by positioning magnet 54 in the mounting plate 34, the location of float 30 and the displacement of spring 36 may be made relative to the mounting plate 34 and not the location of the control unit 50, as described above. Such a method may further improve the accuracy of the density-sensing apparatus 24.

The use of displacement sensor 32 utilizing magnetostrictive technology to determine the location (displacement) of the float 30 provides several advantages for the density-sensing apparatus 24. A primary advantage is the increased sensitivity of the displacement sensor 32 to displacements of the float 30. By way of example, displacement sensor 32 utilizing magnetostrictive technology can sense movements on the order of 0.0005 inch, which leads to very accurate measurements of the spring force, and in turn, very accurate measurements of the density of the fluid. The sensitivity of the displacement sensor 32 to relatively small displacements also permits a large number of data points to be sampled. For example, for a one half inch maximum displacement of the float (and spring), approximately 1,000 data points corresponding to detectable positions of the float 30 may be sampled and analyzed. Moreover, during operation, the exemplary embodiment of density-sensing apparatus 24 may have a density range that varies from about 0.65 g/cc to about 0.9 g/cc. Density-sensing apparatus 24 may therefore be capable of measuring changes in density down to as little as 0.000223 g/cc and thus provide highly accurate density measurements that may be used to improve the accuracy of the fluid volume and leak detection calculations. In addition, density-sensing apparatus 24 having displacement sensor 32 utilizing magnetostrictive technology is relatively inexpensive to manufacturer and thus a more cost effective method to measure and monitor the density of a fluid.

Density-sensing apparatus 24 may also include one or more temperature sensors (not shown) located in shaft 26 to allow density-sensing apparatus 24 to compensate for contraction and expansion of the fluid due to changes in temperature as known to one of ordinary skill in the art. Such a sensor may have an operational temperature range of about −40° C. to about 80° C.

FIG. 3, in which like reference numbers refer to like features in FIG. 2, shows another embodiment of the invention for which density-sensing apparatus 56 includes multiple float assemblies spaced apart along shaft 26, thus allowing apparatus 56 to take density measurements of the fluid at multiple levels within the tank 10. For example, many fuel storage tanks include a bottom layer of water and then fuel above the water within the tank, as shown in FIG. 1. In such a tank, density-sensing apparatus 56 may have at least two float assemblies 28, 28a, wherein float assembly 28 provides an indication of the density of the fuel and float assembly 28a provides an indication of the density of the water, wherein reference numerals on float assembly 28a corresponding to like features on float assembly 28 are proceeded by an a. Alternatively, multiple float assemblies may be positioned in the fuel and/or the water layers. Those of ordinary skill in the art will recognize that the number of float assemblies 28 positioned on shaft 26 may be varied depending on the specific application.

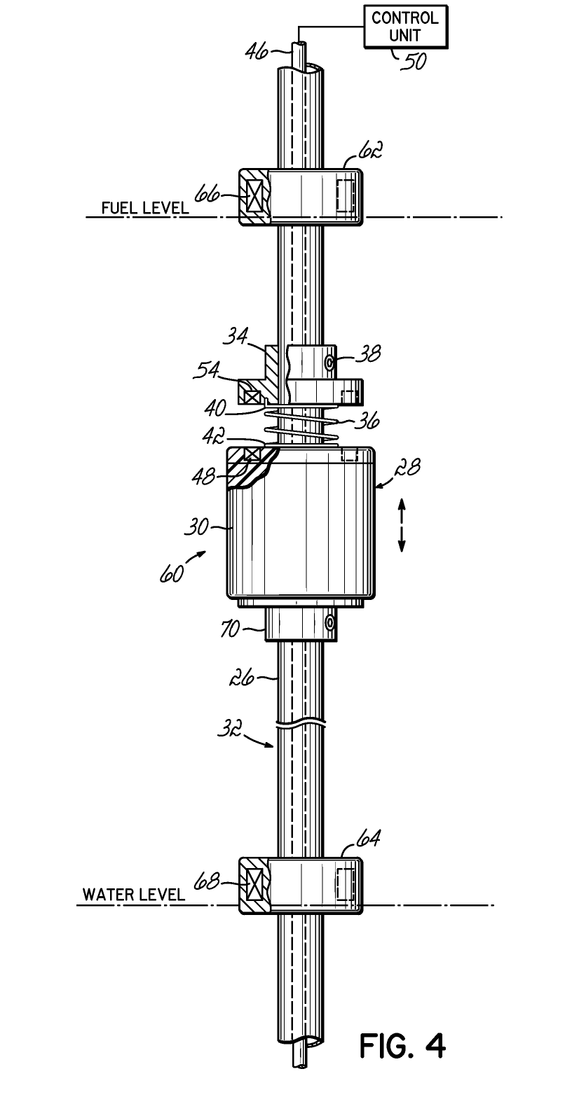

Referring to FIG. 4, in which like reference numerals refer to like features in FIG. 2, another exemplary embodiment of the density-sensing apparatus 60 is shown. In this embodiment, density-sensing apparatus 60 includes a shaft 26, a float assembly 28, and a displacement sensor 32 generally as described above which operates in a manner similar to density-sensing apparatus 24. Consequently, only the modifications included in density-sensing apparatus 60 will be described herein. Density-sensing apparatus 60 further includes a first product float 62 positioned along an upper portion of the shaft 26 and a second product float 64 positioned along a lower portion of the shaft 26. For example, the first product float 62 may be adapted to measure the level of the fuel in tank 10 while the second product float 64 may be adapted to measure the level of the water in tank 10 (see FIG. 1). Each of the first and second product floats 62, 64 include a permanent magnet 66, 68, respectively, coupled thereto which may be similar in construction and operation to magnet 48.

In addition, float assembly 28 may further include a constraint plate 70 positioned on shaft 26 spaced from mounting plate 34 such that float 30 is located therebetween. Constraint plate 70 may be securely coupled to shaft 26 using, for example, a set screw or other connectors known to or yet-to-be developed by one of ordinary skill in the art without departing from the spirit and scope of the invention. In the embodiment shown in FIG. 4, the float assembly 28 is positioned between the first and second product floats 62, 64. In this way, mounting plate 34 prevents float 30 from rising too high and interfering with first product float 62. In a similar manner, constraint plate 70 prevents float 30 from sinking too low and interfering with the second product float 64.

In operation, the magnetic field created by the interrogation pulse traveling down the magnetostrictive waveguide 46 interacts with the magnetic field created by the magnets 66, 68 in the first and second product floats 62, 64 and the magnet 48 in float 30, creating multiple return pulses traveling from each of the floats back down the magnetostrictive waveguide 46. The transducer in control unit 50 picks up these return pulses. Control unit 50 is then configured to not only calculate the fluid levels corresponding to first and second product floats 62, 64, but to also calculate the density of the fluid in the manner as described above. Density-sensing apparatus 60 then advantageously combines multiple functions (i.e., product level and density measurements) into a single apparatus, which then occupies only a single port in manifold 16 (FIG. 1). Those of ordinary skill in the art will recognize that density-sensing apparatus 60 may include multiple float assemblies 28 as described above and shown in FIG. 3. It will also be understood by those of ordinary skill in the art that a magnet 54 may be positioned in mounting plate 34 and used in the density calculation as described above.

Such a multi-functional device as that described above for density-sensing apparatus 60 may be offered to a customer as a new product. In a further advantageous aspect of the invention, however, such a multi-functional device may be readily obtained by providing a retrofit kit that may be combined with existing product level probes utilizing magnetostrictive technology to provide the density-sensing function. For instance, the Model 924 product level probe from OPW Fuel Management Systems, Inc., Hodgkins, Ill. may be retrofitted according to the invention to provide a density-sensing function. To this end, the retrofit kit includes the float assembly 28, i.e., the mounting plate 34, the biasing member (e.g., spring 36) and float 30 having magnet 48. The retrofit kit may further include constraint plate 70 and magnet 54 in mounting plate 34. The existing product level probe may be disassembled and the float assembly 28 selectively positioned on the shaft between the product floats and secured thereto using, for example set screw 38. It will be recognized by those of ordinary skill in the art that multiple float assemblies 28 may be provided in the kit and positioned on the shaft. The now modified product level/density-sensing apparatus may then be re-assembled and inserted back in tank 10. Those of ordinary skill in the art will recognize that the control unit(s) associated with the existing product level probes may have to be re-configured to recognize the float assembly 28 and calculate the density based on readings from the displacement sensor 32.

In yet another embodiment (not shown), instead of coupling the float assembly 28 to the same shaft on which the product floats are carried for the product level probe. A second shaft may be used having a diameter larger than the diameter of the product level probe such that the product level probe may be disposed inside the second shaft. One or more float assemblies 28 may then be operatively and movably coupled to the second shaft. In this way, the float assembly 28 will not interfere with the first and second product floats.

It is understood that any of the embodiments of the density-sensing apparatus may be configured to continuously monitor the fluid density, providing multiple readings over multiple time periods and the control unit may be configured to calculate and use an average of these multiple measurements.

Accordingly, while some of the alternative embodiments of the density-sensing apparatus have been discussed specifically; other embodiments will be apparent or relatively easily developed by those of ordinary skill in the art. For example, while the float described above produced an upward, positive buoyant force, a float that is heavier than the surrounding fluid, and therefore having a negative buoyant force, is also contemplated to be within the scope of the invention. Accordingly, this invention is intended to embrace all alternatives, modifications and variations that have been discussed herein, and others that fall within the spirit and scope of the claims.

What is claimed is:

1. An apparatus for sensing the density of a fluid comprising:
a shaft adapted to be positioned in a fluid;
a biased float disposed on said shaft and capable of movement along said shaft; and
a displacement sensor for detecting a position of said float along said shaft,
wherein said apparatus is configured to sense the density of the fluid based on the position of said float.

2. The apparatus of claim 1, wherein said biased float further comprises:
a mounting plate secured to said shaft; and
a spring having a first end adapted to engage the mounting plate and a second end adapted to engage the float.

3. The apparatus of claim 2, wherein said spring is positioned so as to operate as a compression spring.

4. The apparatus of claim 2, wherein said spring is positioned so as to operate as an extension spring.

5. The apparatus of claim 1, wherein a density of said float is less than a density of the fluid so that a buoyant force acts on said float in a direction opposite to gravity.

6. The apparatus of claim 1, wherein a density of said float is different from a density of the fluid so that a buoyant force acts on said float in a first direction, and wherein said float is biased so as to resist movement in the first direction.

7. The apparatus of claim 1, wherein said displacement sensor is a magnetostrictive sensor.

8. An apparatus for sensing the density of a fluid comprising:
a shaft adapted to be positioned in a fluid within a container;
a first float assembly disposed on said shaft, said first float assembly comprising:
a mounting plate adapted to be secured to said shaft;
a spring having first and second ends, the first end adapted to engage said mounting plate; and
a float adapted to engage the second end of said spring and capable of movement along said shaft; and
a displacement sensor comprising:
a magnetostrictive waveguide disposed along said shaft;
a magnet operatively coupled to said float for movement therewith and in operative relation to said magnetostrictive waveguide; and
pulsing and detection apparatus for detecting a position of said magnet along said magnetostrictive waveguide,
wherein said apparatus is configured to sense the density of the fluid based on the position of the float.

9. The apparatus of claim 8, wherein said mounting plate and said spring are positioned so that said float compresses said spring.

10. The apparatus of claim 8, wherein said mounting plate and said spring are positioned so that said float extends said spring.

11. The apparatus of claim 8, wherein a density of said float is different from a density of the fluid so that a buoyant force acts on said float in a first direction, and wherein said float is biased by said spring so as to resist movement in the first direction.

12. The apparatus of claim 8, further comprising:
a first product float movably disposed on said shaft and configured to sense the level of the fluid in the container.

13. The apparatus of claim 12, wherein said first product float includes a magnet operatively coupled thereto for movement therewith and in operative relation to said magnetostrictive waveguide, said magnet cooperating with said displacement sensor to determine the position of said first product float along said magnetostrictive waveguide.

14. The apparatus of claim 8, further comprising:
a first product float movably disposed on said shaft and configured to sense the level of a first fluid in the container; and
a second product float movably disposed on said shaft and configured to sense the level of a second fluid in the container.

15. The apparatus of claim 14, wherein said first and second product floats each include a magnet operatively coupled thereto for movement therewith and in operative relation to said magnetostrictive waveguide, each of said magnets cooperating with said displacement sensor to determine the position of said first and second product floats along said magnetostrictive waveguide.

16. The apparatus of claim 8, further comprising:
a second float assembly disposed on said shaft and spaced apart from said first float assembly.

17. The apparatus of claim 8, wherein said mounting plate includes a magnet operatively coupled thereto and in operative relation to said magnetostrictive waveguide, said magnet in said mounting plate cooperating with said displacement sensor to determine the position of said mounting plate along said magnetostrictive waveguide.

18. The apparatus of claim 8, further comprising:
a constraint plate disposed on said shaft and spaced from said mounting plate so that said float is disposed therebetween.

19. A density sensor kit for retrofitting a product level probe so as to be able to sense the density of a fluid in a container, the probe including a shaft adapted to be positioned in the fluid within the container, a product float movably disposed on the shaft, and a displacement sensor including a magnetostrictive waveguide disposed along the shaft, and pulsing and detection apparatus for detecting a position of a magnet along the magnetostrictive waveguide, the kit comprising:
a first float assembly adapted to be disposed on the shaft, comprising:
a mounting plate adapted to be secured to the shaft;
a spring having first and second ends, the first end adapted to engage said mounting plate; and
a float adapted to engage the second end of said spring and capable of movement along the shaft when coupled thereto; and
a magnet adapted to be coupled to said float,
wherein said first float assembly is configured to sense the density of the fluid based on the position of the float.

20. The kit of claim 19, further comprising:
a magnet adapted to be operatively coupled to said mounting plate.

21. The kit of claim 19, further comprising:
a constraint plate adapted to be disposed on the shaft and spaced from said mounting plate so that said float is disposed therebetween.

22. A method of sensing the density of a fluid comprising:
positioning a float within the fluid wherein said float has a buoyancy with respect to the fluid;
biasing the float against its buoyancy in the fluid; and
sensing the position of the float to obtain data representative of the density of the fluid.

23. The method of claim 22, wherein sensing the movement of the float further comprises:
sensing the movement magnetostrictively by causing relative movement of one of a magnetostrictive waveguide and a magnet operatively disposed proximate the magnetostrictive waveguide upon movement of the float.

24. A method of monitoring a fluid within a container comprising:
sensing the level of the fluid in the container using a sensor; and
sensing the density of the fluid in the container using the same sensor.

25. The method of claim 24, wherein sensing the level of the fluid and sensing the density of the fluid is done magnetostrictively.

26. A fluid density-sensing apparatus comprising:
an elongated displacement sensor extending into a fluid;
a float in said fluid operatively movable with respect to the displacement sensor; and
calculating apparatus for signaling fluid density as a function of the position of said float with respect to said displacement sensor.

27. The apparatus of claim 26, wherein said displacement sensor is a magnetostrictive sensor.

28. The apparatus of claim 26, further comprising:
biasing apparatus for biasing the float against its buoyancy in the fluid.

29. The apparatus of claim 28, further comprising:
apparatus securing said biasing apparatus to said elongated displacement sensor.
